(19) United States
(12) Patent Application Publication
(10) Pub. No.: US 2022/0009609 A1
(43) Pub. Date: Jan. 13, 2022

(54) RAPID IN-SITU STEERING SYSTEM FOR SHIP

(71) Applicant: Wei Jiang, Kunshan (CN)

(72) Inventor: Wei Jiang, Kunshan (CN)

(21) Appl. No.: 17/471,226

(22) Filed: Sep. 10, 2021

Related U.S. Application Data
(63) Continuation of application No. PCT/CN2020/071190, filed on Jan. 9, 2020.

(30) Foreign Application Priority Data
Mar. 15, 2019 (CN) 201910196259.0

(51) Int. Cl. B63H 5/125; B63H 25/42

(52) U.S. Cl. CPC B63H 5/125; B63H 25/42

(57) ABSTRACT

The present invention discloses a novel in-situ rapid steering system for a ship, including a hull and a steering structure. A front flip structure is arranged at a positioned corresponding to a bow. A rear flip structure is arranged at a position corresponding to a stern. A 360-degree adjustable paddle is mounted at a center of a circle directly below the hull. A steering deck is arranged on the hull. The center of the steering deck is provided with a central shaft. The in-situ fast steering system for the ship is simple to be operated and can be steered in-situ in a narrow water area. A size of the hull can be reduced by steering over the bow and stern into the hull. A direction can be adjusted by driving the steering deck to drive the bow and stern, so that the advantage of rapid in-situ steering can be realized.

### CROSS REFERENCE TO RELATED APPLICATIONS

The present application is a Continuation Application of PCT Application No. PCT/CN2020/071190 filed on Jan. 9, 2020, which claims the benefit of Chinese Patent Application No. 201910196259.0 filed on Mar. 15, 2019. All the above are hereby incorporated by reference in their entirety.

### TECHNICAL FIELD

The present invention relates to the field of ship technologies, and more particularly, to a novel rapid in-situ steering system for a ship.

### BACKGROUND

Ships are a general term for all kinds of ships. Ships are vehicles that can navigate or berth in a water area for transportation or operations, and have different technical performance, equipment and structural types according to different usage requirements.

Ships need to use a steering system when steering, but the steering system of the ship in the prior art does not have the function of in-situ steering in a narrow water area, and there is a risk of a collision when the ship is steered. Therefore, the person skilled in the art provides a novel rapid in-situ steering system for a ship to solve the problems raised in the background.

### SUMMARY

An objective of the present invention is to provide a novel rapid in-situ steering system for a ship, which has the advantage of rapid in-situ steering, solves the problem that a ship in the prior art cannot quickly be steered in a narrow water area, and avoids a risk of a collision when the ship in the prior art is steered.

In order to achieve the above objective, the present invention proposes a novel in-situ rapid steering system for a ship, including a hull (1) and a steering structure. A front flip structure is provided at a position corresponding to a bow. A rear flip structure is provided at a position corresponding to a stern. A 360-degree adjustable paddle (12) is mounted at a center of a circle directly below the hull (1). The steering structure is provided with a steering deck (2). The steering deck (2) is provided on the hull (1). A center of the steering deck (2) is provided with a central shaft (3). The hull (1) is arranged in a circular shape.

The front flip structure is provided with a front flip control motor (5). An output terminal of the front flip control motor (5) is connected to a front flip connecting rod (6), and a flipable bow (7) is fixed on the front flip connecting rod (6).

preferably, the rear flip structure is provided with a rear flip control motor (8). An output terminal of the rear flip control motor (8) is connected to a rear flip connecting rod (9). A waterproof box (10) is fixed on the rear flip connecting rod (9). A drive system (11) is fixed in the waterproof box (10). A right end portion of the drive system (11) is extended to a right outside of the waterproof box (10).

A steering control motor (4) is provided inside the hull (1). An output terminal of the steering motor (4) is configured to drive the steering deck (2) to rotate 360 degrees around the central shaft (3) horizontally.

Compared with the prior art, the present invention has the following beneficial effects:

1. The present invention uses a cooperation of the hull, a circular steering deck, the central shaft, the steering control motor, the front flip control motor, the front flip connecting rod, the flipable bow, the rear flip control motor, the rear flip connecting rod, the waterproof box, the drive system and a 360-degree adjustable propeller to solve the problem that the ship in the prior art cannot steer quickly in-situ in a narrow water area. The in-situ fast steering system for the ship is simple to be operated and can be steered in-situ in a narrow water area. A size of the hull can be reduced by steering over the bow and stern into the hull. A direction can be adjusted by driving the steering deck to drive the bow and stern, so that the advantage of rapid in-situ steering can be realized, thereby reducing a risk of the collision and a required width when the ship is steered.

2. The front flip control motor and the rear flip control motor of the present invention retract the bow and the stern into the hull via the front flip link and the rear flip connecting rod, thereby achieving a function of reducing the size of the hull.

3. The present invention drives the steering deck via the steering control motor, and adjusts a direction by driving the bow and the stern at a fixed position of the steering deck, thereby realizing a function of rapid in-situ steering.

4. A steering process of the present invention is all completed in the hull, thereby avoiding a risk of the collision.

5. The steering process of the present invention is all completed on the water surface, thereby reducing a resistance of water flow during the steering process.

### BRIEF DESCRIPTION OF THE DIAGRAMS

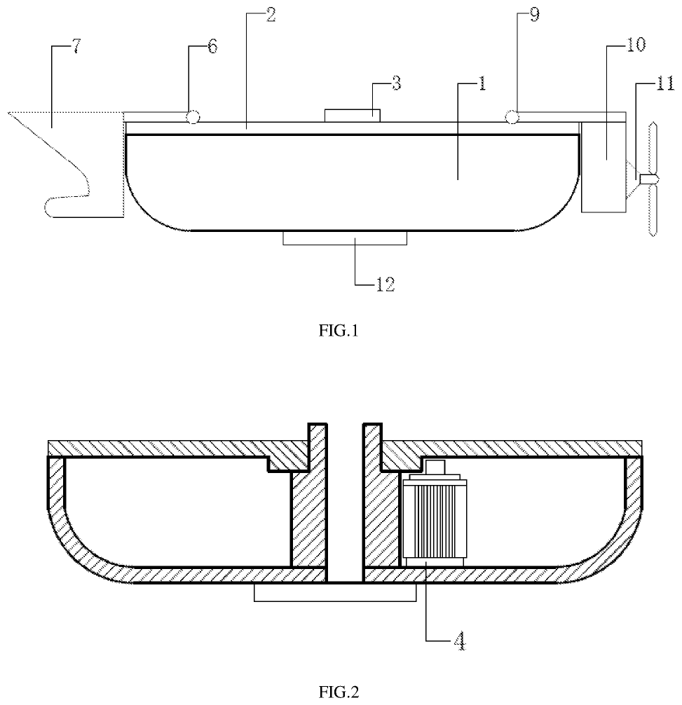

FIG. 1 is a schematic structural diagram of a novel in-situ rapid steering system for a ship according to Embodiment 1 of the present invention;

FIG. 2 is an internal cross-sectional diagram of a hull of a novel rapid in-situ steering system for a ship in Embodiment 2 of the present invention; and

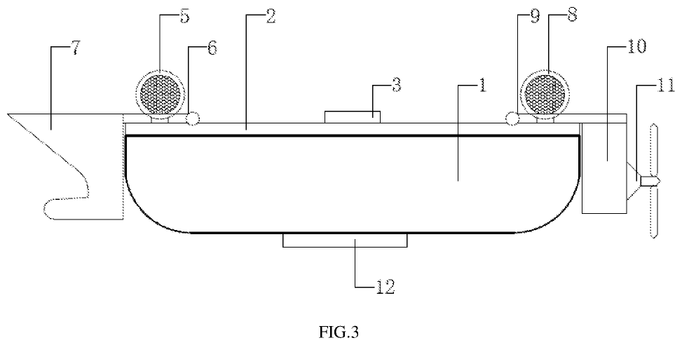

FIG. 3 is a schematic structural diagram of a novel in-situ rapid steering system for a ship according to Embodiment 2 of the present invention.

In the figures: 1—hull, 2—steering deck, 3—central shaft, 4—steering control motor, 5—front flip control motor, 6—front flip connecting rod, 7—flipable bow, 8—rear flip control motor, 9—rear flip connecting rod, 10—waterproof box, 11—drive system, 12—360-degree adjustable paddle.

### DESCRIPTION OF THE INVENTION

The following clearly and completely describes the technical solutions in embodiments of the present invention in conjunction with the drawings in the embodiments of the present invention. Obviously, the described embodiments are only a part of the embodiments of the present invention, rather than all embodiments. Based on the embodiments of the present invention, all other embodiments obtained by the person skilled in the art without creative work shall fall within the protection scope of the present invention.

### Embodiment 1

Please refer to FIG. 1, in order to achieve the above objective, the present invention proposes a novel in-situ rapid steering system for a ship, including a hull 1 and a steering structure. A front flip structure is provided at a position corresponding to a bow. A rear flip structure is provided at a position corresponding to a stern. A 360-degree adjustable paddle 12 is mounted at a center of a circle directly below the hull 1. The steering structure is provided with a steering deck 2. The steering deck 2 is provided on the hull 1. A center of the steering deck 2 is provided with a central shaft 3. The hull 1 is arranged in a circular shape. The steering deck 2 can rotate 360 degrees around the central shaft 3 horizontally.

In this embodiment, the front flip structure includes a front flip connecting rod 6. A flipable bow 7 is fixed at the front flip connecting rod;

The rear flip structure includes a rear flip connecting rod 9. A waterproof box 10 is fixed on the rear flip connecting rod 9. A drive system 11 is fixed in the waterproof box 10. A right end portion of the drive system 11 is extended to a right outside of the waterproof box 10.

In this embodiment, a working principle is as follows: during the daily travel of the ship, an operator controls a travel direction of the hull 1 by controlling the adjustable paddle 12, uses the drive system 11 to give the ship a power to move forward, reduces a resistance for the advancement of the ship while steering the bow 7, and ensures the normal movement of the ship. When the ship needs to steer in-situ, the operator can receive the flipable bow 7 and the waterproof box 10 in the ship by the front steering connecting rod 6 and the rear steering connecting 9, thereby reducing a radial length of the ship. After reducing a size of the hull, the operator manipulates a horizontal rotation of the circular steering deck 2 to drive a bow and stern system to rotate relative to the hull 1. When the bow and the stern are steered to a target direction, the hull 1 steers quickly in-situ. The present invention solves the problem that the ship in the prior art cannot quickly steer in-situ. The in-situ fast steering system for the ship is simple to be operated and can be steered in-situ in a narrow water area. A size of the hull can be reduced by steering over the bow and stern into the hull. A direction can be adjusted by driving the steering deck to drive the bow and stern, so that the advantage of rapid in-situ steering can be realized, thereby reducing a required width when the ship is steered and reducing a risk of a collision when the ship is steered.

The in-situ rapid steering system for the ship uses a cooperation of the hull 1, the steering deck 2, the central shaft 3, the front flip link 6, the flipable bow 7, the rear flip connecting rod 9, the waterproof box 10, the drive system 11 and the 360-degree adjustable paddle 12 to solve the problem that the ship in the prior art cannot steer quickly in-situ in a narrow water area. The in-situ fast steering system for the ship is simple to be operated and can be turned in-situ in a narrow water area. A size of the hull can be reduced by turning over the bow and stern into the hull. A direction can be adjusted by driving the steering deck to drive the bow and stern, so that the advantage of rapid in-situ turning can be realized. The foldable design of the front flip structure and the rear flip structure reduces the width required when the ship is steered, and reduces a resistance of the water flow and the risk of the collision.

In this embodiment, the hull 1 is arranged in a circular shape, which is convenient for the in-situ reversal of the hull, and it is not difficult to realize the in-situ reversal due to an excessive length of a traditional ship.

In this embodiment, a bow system and a stern system of the hull 1 have a similar weight, which can increase a stability of the system during steering and prevent the hull from tilting.

### Embodiment 2

As shown in FIG. 3, a basic structure of Embodiment 2 is the same as that of Embodiment 1, and a difference feature thereof is that: the front flip structure is provided with a front flip control motor 5. An output terminal of the front flip control motor 5 is connected to a front flip connecting rod 6, and a flipable bow 7 is fixed on the front flip connecting rod 6.

A rear flip structure is provided with a rear flip control motor 8. An output terminal of the rear flip control motor 8 is connected to a rear flip connecting rod 9. A waterproof box 10 fixed on the rear flip connecting rod 9. A drive system 11 is fixed in the waterproof box 10. A right end portion of the drive system 11 is extended to a right outside of the waterproof box 10.

In Embodiment 1, the front flip connecting rod 6 and the rear flip connecting rod 9 is manually flipped and reversed, which may be difficult for people with low strength to realize the forgoing operation. Flipping and reversal are achieved by arranging the front steering control motor 5 to drive the front steering link 6. The flipping and reversal are realized by the rear flip control motor 8 to drive the rear flip connecting rod 9, so that the reversal of a front flip structure and the rear flip structure becomes more labor-saving and easy to be implemented.

In addition, in this embodiment, as shown in FIG. 2, a steering control motor 4 is provided inside the hull 1. An output terminal of the steering motor 4 is configured to drive the steering deck 2 to rotate 360 degrees around a central shaft 3 horizontally. Owing to the arrangement of the steering motor, a rotation of a steering plywood 2 need not be driven manually, thereby saving effort, and facilitating the reversal of the ship.

The forgoing are only specific embodiments of the present invention, but the protection scope of the present invention is not limited thereto. The person skilled in the art can easily make changes or substitutions within the technical scope disclosed by the present invention according to the technical solution and its invention conception, which should be covered within the protection scope of the present invention.

What is claimed is:

1. A rapid in-situ steering system for a ship, comprising a hull (1) and a steering structure, a front flip structure is arranged at a position corresponding to a bow, a rear flip structure is arranged at a position corresponding to a stern, a 360-degree adjustable paddle (12) is mounted at a center of a circle directly below the hull (1), the steering structure is provided with a steering deck (2), the steering deck (2) is provided on the hull (1), a center of the steering deck (2) is provided with a central shaft (3), the hull (1) is arranged in a circular shape; the rear flip structure is provided with a rear flip control motor (8), an output terminal of the rear flip control motor (8) is connected to a rear flip connecting rod (9), a waterproof box (10) is fixed on the rear flip connecting rod (9), a drive system (11) is fixed in the waterproof box (10), and a right end portion of the drive system (11) is extended to a right outside of the waterproof box (10).

2. The in-situ rapid steering system for the ship according to claim 1, wherein the front flip structure is provided with a front flip control motor (5), an output terminal of the front flip control motor (5) is connected to a front flip connecting rod (6), and a flipable bow (7) is fixed on the front flip connecting rod (6).

3. The in-situ rapid steering system for the ship according to claim 1, wherein a steering control motor (4) is provided inside the hull (1), and an output terminal of the steering motor (4) is configured to drive the steering deck (2) to rotate 360 degrees around the central shaft (3) horizontally.
